(19) United States
(12) Patent Application Publication
(10) Pub. No.: US 2015/0009860 A1
(43) Pub. Date: Jan. 8, 2015

(54) SETTING SYSTEM AND METHOD FOR SETTING INTERFACES OF CONNECTION APPARATUS CONNECTED TO ELECTRONIC DEVICE

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: DONG-YAN LI, Shenzhen (CN); BING ZHOU, Shenzhen (CN)

(21) Appl. No.: 14/325,358

(22) Filed: Jul. 7, 2014

(30) Foreign Application Priority Data
Jul. 8, 2013 (CN) 201310284306X

(51) Int. Cl. H04L 12/24

(52) U.S. Cl. CPC H04L 41/0816
USPC 370/254

(57) ABSTRACT

A setting system, and method for setting first interfaces of a connection apparatus, includes a detection unit, a search unit, a setting unit, and a turn on unit. The detection unit detects second interfaces which are connected to the connection apparatus and the search unit obtains name and speed-capability information of each connected second interface. Based on the obtained information, the setting unit issues a first command to control each of connected first interfaces to connect to a second interfaces at a speed in accordance with the obtained information. The turn on unit issues a second command to turn on the connected first interfaces in accordance with the obtained information when any connection is broken.

### CROSS-REFERENCE TO RELATED APPLICATIONS

This application claims priority to Chinese Patent Application No. 201310284306.X filed on Jul. 8, 2013 in the China Intellectual Property Office, the contents of which are incorporated by reference herein.

### FIELD

The present disclosure relates to data transmission and exchange.

### BACKGROUND

A connection apparatus usually has a plurality of interfaces. The connection apparatus couples to an electronic device through one of the interfaces. Once the electronic device is replaced by another or the interface is changed, the interface must be set manually.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of an electronic device and a connection apparatus.

FIG. 2 is a interface list created by a search unit of FIG. 1.

FIG. 3 is a flowchart of a setting method for setting interfaces of the connection apparatus of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

The present disclosure describes a setting system and a method for setting first interfaces of a connection apparatus. The setting system includes a detection unit, a search unit, a setting unit and a turn on unit. The detection unit detects one or more connected second interfaces of a number of second interfaces which are connected to the connection apparatus. The search unit obtains name and speed capacity information of each of the connected second interfaces. The setting unit issues a first command associated with the obtained information and controls each first interfaces of a number of first interfaces which are connected to the connected second interfaces to each connect themselves to a connected second interface, at a speed suitable to the second interface with which the first interface connects. The turn on unit issues a second command to turn on the connected first interfaces.

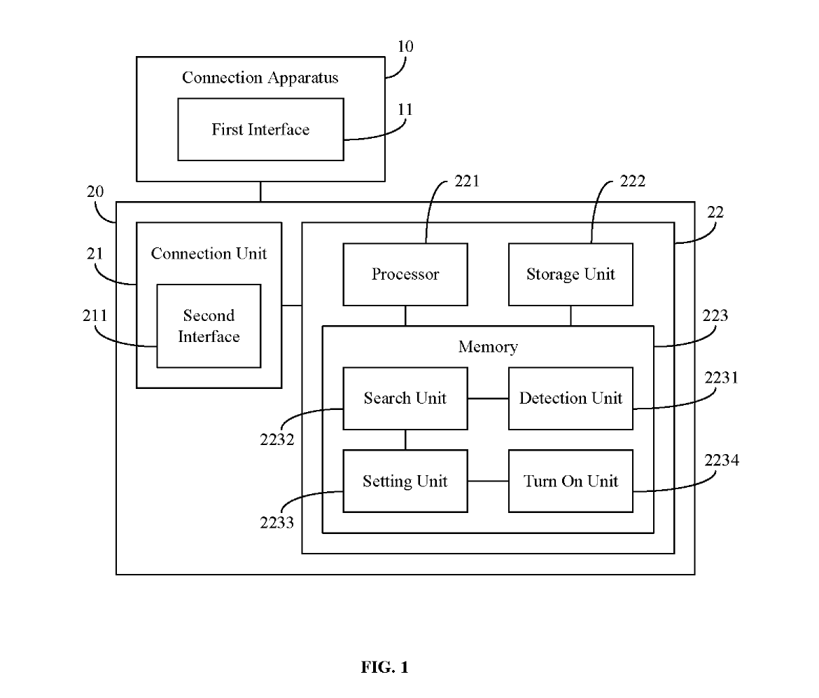

FIG. 1 illustrates an embodiment of an electronic device 20. The electronic device 20 is electrically coupled to a connection apparatus 10. The connection apparatus 10 can include a plurality of first interfaces 11. The electronic device 20 can include a connection unit 21 and a setting system 22. The connection unit 21 can include a plurality of second interfaces 211. The connection apparatus 10 is coupled to the electronic device 20 by wired connections between the first interfaces 11 and the second interfaces 211.

The setting system 22 can include a processor 221 and a storage unit 222. The processor 221 executes instructions of a detection unit 2231, a search unit 2232, a setting unit 2233 and a turn on unit 2234. The instructions of the detection unit 2231, the search unit 2232, the setting unit 2233 and the turn on unit 2234 are stored in a memory 223 of the electronic device 20.

The detection unit 2231 detects all of the second interfaces 211 which are available and detects one or more second interfaces 211 (hereinafter “connected second interfaces 211”) which are connected to the first interfaces 11. The detection unit 2231 sends a request to each of the plurality of second interfaces 211 and obtains a feedback message from each of the connected second interfaces 211.

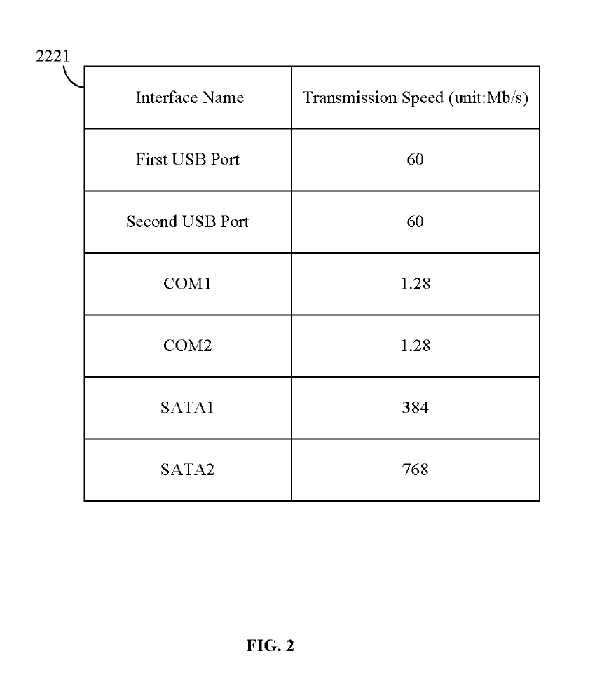

The search unit 2232 searches all of the connected second interfaces 211 and obtains information relating to the connected second interfaces 211. In at least one embodiment, the information can include a name and a transmission speed of each of the connected second interfaces 211. The search unit 2232 creates an interface list 2221 (shown in FIG. 2) recording the obtained information. The storage unit 222 stores the interface list 2221.

The setting unit 2233 issues a first command associated with the information as to the connected second interfaces 211 recorded in the interface list 2221 and controls one or more first interfaces 11 (hereinafter “connected first interfaces 11”) which are connected to the connected second interfaces 211 to channel data through the connected second interfaces 211 in accordance with the information recorded in the interface list 2221. In at least one embodiment, the information can include respective names and transmission speeds of the connected second interfaces 211. The setting unit 2233 issues the first command and controls each connected first interface 11 to associate with a connected second interface, and controls the connected first interface to output data at a speed which is equal to the capacity of the connected second interface which has been associated with the connected first interface.

When a connected first interface 11 is disconnected, the connected first interface 11 is turned off. The turn on unit 2234 issues a second command and turns on each of the connected first interfaces 11.

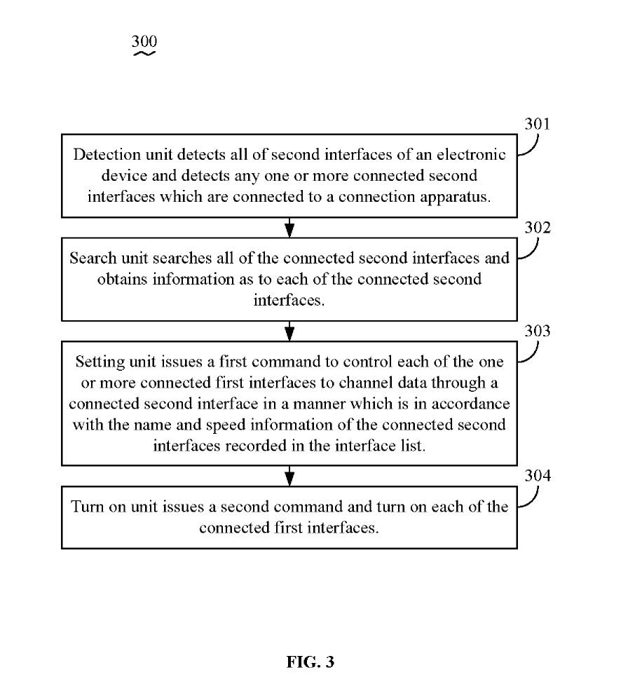

Referring to FIG. 3, a flowchart of an embodiment of an example method 300 is presented. The example method 300 is provided by way of example, as there are a variety of ways to carry out the embodiment. The example method 300 described below can be carried out using the configurations illustrated in FIG. 1, and various elements of these figures are referenced in explaining the example method 300. Each block shown in FIG. 3 represents one or more processes, methods, or subroutines, carried out in the exemplary method 300. Additionally, the illustrated order of blocks is by example only and the order of the blocks can change. The example method 300 can begin at block 301.

At block 301, a detection unit detects all of second interfaces of an electronic device and detects any one or more connected second interfaces which are connected to a connection apparatus. The detection unit sends a request to each of the second interfaces and obtains a feedback message from each of the connected second interfaces.

At block 302, a search unit searches all of the connected second interfaces and obtains information as to each of the connected second interfaces. In at least one embodiment, the information can include a respective name and a transmission speed of each of the connected second interfaces. The search unit creates an interface list to record the obtained information.

At block 303, a setting unit issues a first command to control each of the one or more connected first interfaces to channel data through a connected second interface in a manner which is in accordance with the name and speed information of the connected second interfaces recorded in the interface list.

At block 304, a turn on unit issues a second command and turn on each of the connected first interfaces.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular matters of shape, size and arrangement of the parts within the principles of the present disclosure, up to and including the full extent established by the broad general meaning of the terms used in the claims.

What is claimed is:

1. An electronic device having an interface setting function, the electronic device being electrically coupled to a connection apparatus comprising a plurality of first interfaces, the electronic device comprising:
a connection unit comprising a plurality of second interfaces, at least one of the plurality of second interfaces being connected to at least one of the plurality of first interfaces of the connection apparatus respectively;
a detection unit configured to find out connected second interfaces among second interfaces of a connection unit, the connected second interfaces being one or more second interfaces among the second interfaces which are connected to the first interfaces;
a search unit configured to obtain information of each of the connected second interfaces;
a setting unit configured to issue a first command associated with the information of the connected second interfaces and control each of connected first interfaces among the first interfaces which are connected to the connected second interfaces to associate corresponding information with the information of the connected second interfaces; and
a turn on unit configured to issue a second command to turn on the connected first interfaces.

2. The electronic device of claim 1, wherein the search unit creates an interface list recording the obtained information.

3. The electronic device of claim 1, wherein the detection unit sends a request to each of the second interfaces and obtains a feedback message from each of the connected second interfaces.

4. The electronic device of claim 1, wherein the obtained information includes names and transmission speeds of each of the connected second interfaces, the setting unit issues the first command and controls each of the connected first interface to be associated with a name of a corresponding connected second interface, and controls the connected first interface to transmit data with a transmission speed of the corresponding connected second interface whose name is associated with the connected first interface.

5. A setting system for setting first interfaces of a connection apparatus, the setting system comprising:
a processor configured to execute instructions of the following units stored in a memory;
a detection unit configured to find out connected second interfaces among second interfaces of a connection unit, the connected second interfaces being one or more second interfaces among the second interfaces which are connected to the first interfaces;
a search unit having instructions to obtain information of each of the connected second interfaces;
a setting unit configured to issue a first command associated with the information of the connected second interfaces and control each of connected first interfaces among the first interfaces which are connected to the connected second interfaces to associate corresponding information with the information of the connected second interfaces; and
a turn on unit having instructions to issue a second command to turn on the connected first interfaces.

6. The setting system of claim 5, wherein the search unit creates an interface list recording the obtained information.

7. The setting system of claim 5, wherein the detection unit sends a request to each of the second interfaces and obtains a feedback message from each of the connected second interfaces.

8. The setting system of claim 5, wherein the obtained information includes names and transmission speeds of each of the connected second interfaces, the setting unit issues the first command and controls each of the connected first interface to be associated with a name of a corresponding connected second interface, and controls the connected first interface to transmit data with a transmission speed of the corresponding connected second interface whose name is associated with the connected first interface.

9. A setting method for setting first interfaces of a connection apparatus, the setting method comprising:
finding out connected second interfaces among second interfaces of a connection unit, the connected second interfaces being one or more second interfaces among the second interfaces which are connected to the first interfaces;
obtaining information of each of the connected second interfaces;
issuing a first command associated with the information of the connected second interfaces and controlling each of connected first interfaces among the first interfaces which are connected to the connected second interfaces to associate corresponding information with the information of the connected second interfaces; and
issuing a second command to turn on the connected first interfaces.

10. The setting method of claim 9, wherein obtaining information of each of second interfaces of a connection unit comprising creating an interface list recording the obtained information.

11. The setting method of claim 9, wherein finding out connected second interfaces among the second interfaces, the connected second interfaces being one or more second interfaces among the second interfaces which are connected to the first interfaces comprising sending a request to each of the second interfaces and obtaining a feedback message from each of the connected second interfaces.

12. The setting method of claim 9, wherein issuing a first command associated with the information of the connected second interfaces and controlling each of connected first interfaces among the first interfaces which are connected to the connected second interfaces to associate corresponding information with the information of the connected second interfaces comprising issuing the first command and controlling each of the connected first interface to be associated with a name of a corresponding connected second interface, and controlling the connected first interface to transmit data with a transmission speed of the corresponding connected second interface whose name is associated with the connected first interface.
